(19) United States
(12) Patent Application Publication
(10) Pub. No.: US 2026/0211971 A1
(43) Pub. Date: Jul. 23, 2026

(54) ROTARY POSITIONAL EMBEDDING FUSED GENERAL MATRIX MULTIPLICATION KERNEL

(71) Applicant: QUALCOMM Incorporated, San Diego, CA (US)

(72) Inventors: Vinnam KIM, Seoul (KR); Jaeseong YOU, Seoul (KR); Seokjun AN, Goyang-si (KR); Seungjae SHIN, Seoul (KR); Hyunjae KIM, Seoul (KR); Eungyo SUH, Seoul (KR); Geunho LEE, Seoul (KR)

(21) Appl. No.: 19/034,444

(22) Filed: Jan. 22, 2025

(51) Int. Cl. G06F 17/16; G06N 3/08

(52) U.S. Cl. CPC G06F 17/16; G06N 3/08

(57) ABSTRACT

Systems and techniques are described herein for data processing. For example, a computing device can process, using a computing core of the at least one processor, a plurality of tensors using a general matrix multiplication (GEMM) kernel to generate a first kernel output. The computing device can store the first kernel output in local memory of the computing core. The computing device can process, using a rotary positional embedding (RoPE) function at the computing core, the first kernel output to generate a RoPE of the first kernel output, wherein the ROPE function is included as an epilogue of the GEMM kernel.

### FIELD

The present disclosure generally relates to data processing using rotary positional embedding (RoPE) functions and a general matrix multiplication (GEMM) kernel. For example, aspects of the present disclosure relate to systems and techniques for a rotary ROPE fused GEMM kernel.

### BACKGROUND

Processors (including computing processing units CPUs and general processing units GPUs) execute instructions, process data, and manage computing resources of a computing system or device. Processors generally include processing units (also referred to as computing cores) to perform various operations such as arithmetic operations, logical operations, and control operations. In further examples, processors often include registers for storing temporary data, such as data used during a sequence of computations of the computing core. Registers generally are generally a part of a computing core to provide low latency access by the computing core during operations. Processors also generally include a cache to store frequently and recently used information. The cache is generally located at a processor however because the cache is generally located outside of the computing core, the cache generally does not provide as low of latency as a register. Processors also generally can access a main memory pool, such as dynamic random-access memory (DRAM) which is generally slower than the cache, register, and other local memory of the processors.

Different processor architectures can perform the same or similar operations at different efficiencies (e.g., different speeds and using different amounts of computing resources or power) due in part to design preferences or trade-offs based on an intended use of the processor. Improvements to the efficiency in operations of a processor can enhance overall computing system performance by reducing time and resources required to execute the operations.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for data processing is provided. The apparatus includes at least one memory and at least one processor coupled to the at least one memory and configured to: process, using a computing core of the at least one processor, a plurality of tensors using a general matrix multiplication (GEMM) kernel to generate a first kernel output; store the first kernel output in local memory of the computing core; and process, using a rotary positional embedding (RoPE) function at the computing core, the first kernel output to generate a ROPE of the first kernel output, wherein the ROPE function is included as an epilogue of the GEMM kernel.

In some aspects, a method for data processing is provided. The method includes: processing, using a computing core of the at least one processor, a plurality of tensors using a general matrix multiplication (GEMM) kernel to generate a first kernel output; storing the first kernel output in local memory of the computing core; and processing, using a rotary positional embedding (RoPE) function at the computing core, the first kernel output to generate a RoPE of the first kernel output, wherein the ROPE function is included as an epilogue of the GEMM kernel.

In some aspects, a non-transitory computer-readable medium is provided having stored thereon instructions that, when executed by at least one processor, cause the at least one processor to: process, using a computing core of the at least one processor, a plurality of tensors using a general matrix multiplication (GEMM) kernel to generate a first kernel output; store the first kernel output in local memory of the computing core; and process, using a rotary positional embedding (RoPE) function at the computing core, the first kernel output to generate a RoPE of the first kernel output, wherein the ROPE function is included as an epilogue of the GEMM kernel.

In some aspects, an apparatus for data processing is provided. The apparatus includes: means for processing, using a computing core of the at least one processor, a plurality of tensors using a general matrix multiplication (GEMM) kernel to generate a first kernel output; means for storing the first kernel output in local memory of the computing core; and means for processing, using a rotary positional embedding (RoPE) function at the computing core, the first kernel output to generate a ROPE of the first kernel output, wherein the ROPE function is included as an epilogue of the GEMM kernel.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SoC), in accordance with some aspects of the present disclosure;

FIG. 2 is a block diagram of an example transformer, in accordance with some aspects of the disclosure;

FIG. 3 is a block diagram of an example rotary positional embedding (RoPE) fused general matrix multiplication (GEMM) kernel, in accordance with some aspects of the disclosure;

FIG. 4 is a block diagram of example characteristics of a fusible operation performable using a ROPE fused GEMM kernel, in accordance with some aspects of the disclosure;

FIG. 5 is a block diagram of an example algorithm for performing fifth order polynomial estimation of trigonometric operations to be performed using a ROPE fused GEMM kernel; in accordance with some aspects of the disclosure;

FIG. 6 is a flowchart diagram illustrating an example of a process for data processing; in accordance with some aspects of the disclosure;

FIG. 7 is a block diagram illustrating an example neural network; in accordance with some aspects of the disclosure;

FIG. 8 is a block diagram illustrating an example convolutional neural network; in accordance with some aspects of the disclosure;

FIG. 9 is a block diagram illustrating example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As previously mentioned, processors (including computing processing units CPUs and general processing units GPUs) execute instructions, process data, and manage computing resources of a computing system or device. Processors generally include processing units (also referred to as computing cores) to perform various operations such as arithmetic operations, logical operations, and control operations. In further examples, processors often include registers for storing temporary data, such as data used during a sequence of computations of the computing core. Registers generally are generally a part of a computing core to provide low latency access by the computing core during operations. Processors also generally include a cache to store frequently or recently used information. The cache is generally located at a processor however because the cache is generally located outside of the computing core, the cache generally does not provide as low latency as a register.

Different processor architectures can perform the same or similar operations at different efficiencies (e.g., different speeds and using different amounts of computing resources or power) due in part to design preferences or trade-offs based on an intended use for the processor. Improvements to the efficiency in operations of a processor can enhance overall computing system performance by reducing time and resources required to execute the operations. For example, some architectures can be designed to execute high volume of simple instructions quickly, making such an architecture well-suited for scenarios prioritizing energy efficiency and speed, such as processing data on a portable electronic device. Other architectures can prioritize performing complex instructions in fewer cycles which can be preferable for processors intended to handle computationally intensive workloads.

Rotary positional embedding (RoPE) (also referred to as rotary position embedding) functions can be used to encode positional information about data (e.g., a plurality of tokens, tensors, or other data) in a sequence. RoPE embeddings represent positional information of data in a sequence within a multi-dimensional space. For example, traditional position embeddings generally can indicate locations of data in terms of an absolute position within a sequence. RoPE embeddings can indicate an absolute location of data within a sequence and the location of data within the sequence relative to other data within the sequence. RoPE functions can be used by machine learning models such as neural networks, transformers, large language models (LLM), and other machine learning models and architectures to determine relationships between data within a sequence or matrix.

ROPE functions can apply trigonometric operations to inputs and adjust an angle of rotation of the vector based on a rotation angle associated with the position of the data within a sequence or matrix. An example RoPE function can include:

$$Q = RoPE ( {W}_{Q} x ) = RoPE ( q ) = ( \begin{matrix}{q}_{1} \\ {q}_{2} \\ ⋮\end{matrix} ) ⊙ ( \begin{matrix}cos m {θ}_{1} \\ cos m {θ}_{1} \\ ⋮\end{matrix} ) + ( \begin{matrix}- {q}_{2} \\ {q}_{1} \\ ⋮\end{matrix} ) ⊙ ( \begin{matrix}sin m {θ}_{1} \\ sin m {θ}_{1} \\ ⋮\end{matrix} ) where$$

$${W}_{q} ∈ {ℝ}^{m \times n} ; q , x ∈ {ℝ}^{n \times 1} , m ∈ ℤ , and {θ}_{i} ∈ ℝ .$$

In such an example, m can be a positional index indicating a position of data (e.g., a token from a plurality of tokens, a tensor from a plurality of tensors, a value from a tensor) within a sequence or matrix of data. The W_{q} can represent a matrix of data to be processed using the ROPE function, such as a tensor from an input layer (or another layer) of a neural network. Element x can represent another matrix such an another tensor from an input layer (or another layer) of a neural network. In such an example, θ₁ can represent a rotation angle of the ROPE function to determine a rotation angle of input data to the ROPE function. For example, θ₁ can represent a base frequency of the ROPE function, which can be a constant value scaled based on m (e.g., based on the dimensions or position of data input to the ROPE function within a sequence of data). Element q can represent the result of matrix multiplication of W_{Q}x. In such an example, q can represent the output of general matrix multiplication (GEMM) kernel.

General matrix multiplication (GEMM) can refer to a linear algebra operation of performing matrix multiplication (e.g., a dot product). A GEMM kernel is an implementation of GEMM (e.g., implementation of GEMM in hardware such as computing cores of a processor). The GEMM kernel can be hardware specific (e.g., designed to be implemented in a particular processor architecture). In such an example, GEMM kernels can designed based on the type of processor architecture and can be different when implemented in a first processor architecture (e.g., a processor with multi-threading or parallelization) than a second processor architecture (e.g., a processor with single instruction multiple data (SIMD) vectorization).

Many machine learning models use GEMM and RoPE functions to process data. As previously mentioned, ROPE functions can be used to generate embeddings which can include an absolute position of data in a sequence and a position of data in reference to other data from the sequence, which can be used by a machine learning model to determine relationships between data in the sequence. GEMM can be used in machine learning models to perform operations such as determining weighted sums in fully connected layers and attention mechanisms in transformers.

Improvements to GEMM and ROPE functions (e.g., improvements in how a processor performs operations using GEMM and RoPE functions) can improve operation of a machine learning model and processor by improving latency and reducing computational resources used by the machine learning model and processor.

Systems, apparatuses, electronic devices, methods (also referred to as processes), and computer-readable media (collectively referred to herein as “systems and techniques”) are described herein data processing. For example, the systems and techniques are described herein for a ROPE fused GEMM kernel. In some aspects, the RoPE function can be included as an epilogue of GEMM operations of the GEMM kernel. For example, the GEMM kernel include a sequence of operations to perform on data. The ROPE function can be added to the list of operations to be performed in the sequence of operations. In such an example, the ROPE function can use outputs of GEMM operations stored in a register of a computing core to generate embeddings (e.g., a RoPE).

In some aspects, the inputs to the GEMM kernel can be data such as a plurality of tensors. The tensors can be from an input layer of a machine learning model (or another layer). In some examples, the data can be queries, keys, and/or key/value pairs. The GEMM kernel can perform matrix multiplication on the input data (e.g., on one or more tensors of a plurality of tensors). In some examples, the systems and techniques can include quantizing the data input to the GEMM kernel. For example, the data can be a float type value. The systems and techniques can include quantizing the data to an integer (e.g., 8 bit integer INT8, 16 bit integer INT16, etc.). In such an example, the output of the GEMM kernel (also referred to as a kernel output) can be an integer.

In some aspects, the systems and techniques can include performing the ROPE function on the kernel output. For example, the output of the GEMM kernel can be stored in a register (e.g., local memory) of a computing core. The ROPE function can be part of an epilogue of the GEMM kernel. The epilogue (e.g., the ROPE function of the epilogue) can access the kernel output stored in the register to generate a ROPE based on the kernel output. In some examples, the kernel output includes one or more matrices of values.

In some aspects, the ROPE function can access multiple kernel outputs of the register to perform RoPE operations. In other examples, the ROPE function can access parts of a kernel output stored in the register. For example, the ROPE function can access multiple consecutive or subsequent kernel outputs or portions of kernel outputs. In such an example, inputs to the ROPE function can include a first kernel output and a second kernel output. The ROPE function can include various trigonometric operations, such as multiplying kernel outputs by sine or cosine functions.

In some aspects, the systems and techniques can include systems and techniques can include using floating-point calculations in the ROPE function. For example, when the kernel output is a floating-point value, the ROPE function can use floating point representations of trigonometric operations (e.g., floating point representations of sine and cosine functions). In other examples, such as when the kernel output is a quantized value, such as an integer, the ROPE function can use an integer representation (or approximation) of the trigonometric operations.

In such an example, the trigonometric operations can be fifth order polynomial approximations of the trigonometric operations (e.g., a polynomial with five variables to approximate a sine or cosine function). In some examples, higher or lower order polynomial approximations can be used (e.g., fourth order, sixth order, seventh order, etc.).

In some aspects, the ROPE infused GEMM kernel can be implemented in a machine learning model, such as a machine learning model with transformer architecture. In further examples, the ROPE infused GEMM kernel can be implemented in a large language model (LLM). In such an example, the ROPE infused GEMM kernel can generate RoPE using queries and keys. RoPE representations of the queries and keys can be provided to a self-attention layer or multi-head attention layer of the machine learning model.

Various aspects of the present disclosure will be described with respect to the figures.

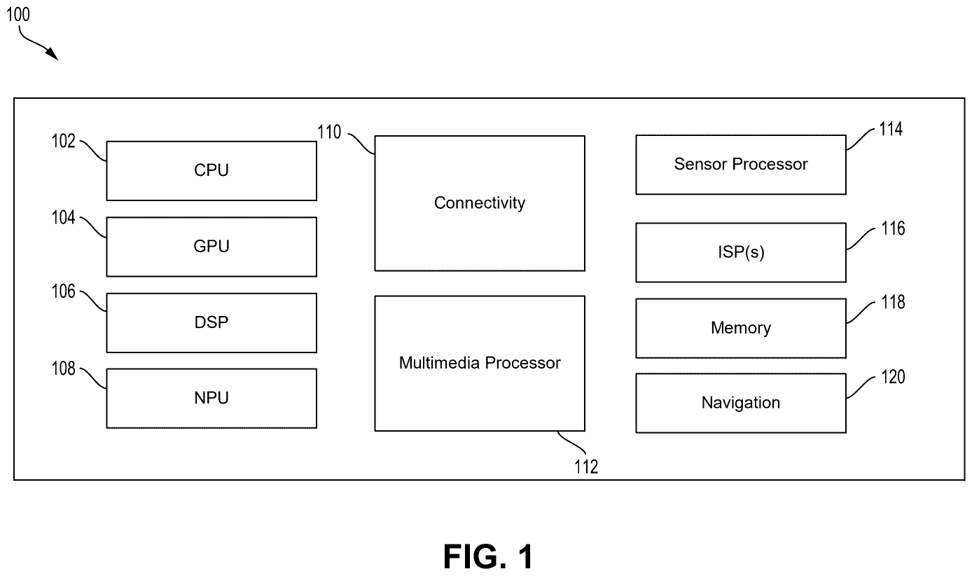

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize audio signals. In one implementation, the NPU is implemented in the CPU 102, DSP 106, and/or GPU 104. The SOC 100 may also include one or more sensors 114 such as but not limited to one or more microphones, image signal processors (ISPs) 110, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured generate explanations for actions performed (e.g., to be performed, predicted to be performed, etc.) by a machine learning model. The explanations can be one or more of a text-based description, set of instructions to perform a sub-task or task, etc. according to aspects of the present disclosure discussed herein. The SOC can be used to operate various machine learning models for image processing, text processing, feature extraction, signal controls generation, etc. For example, SOC 100 and/or components thereof may be configured to perform processing techniques such as but not limited to: segment shifting, shuffle correlation, gain shifting, segment masking, and additional processing techniques. SOC 100 can be part of a computing device or multiple computing devices. In some examples, SOC 100 can be part of an electronic device (or devices) such as an audio recording device, camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IOT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of audio can benefit from first learning to recognize individual spoken words, instruments in music, etc. These features may be combined at higher layers in different ways to recognize sounds such as speech, instruments, wind noise, etc.

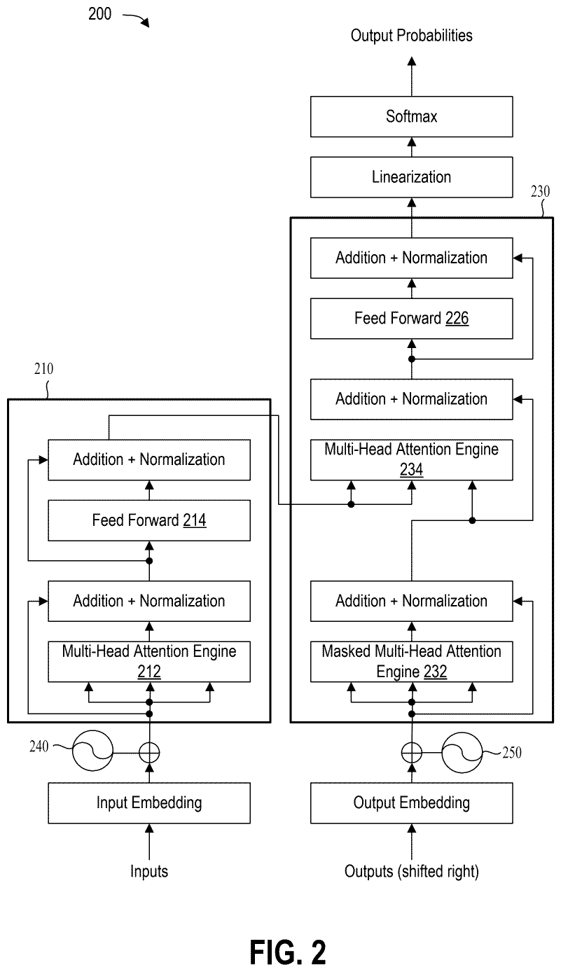

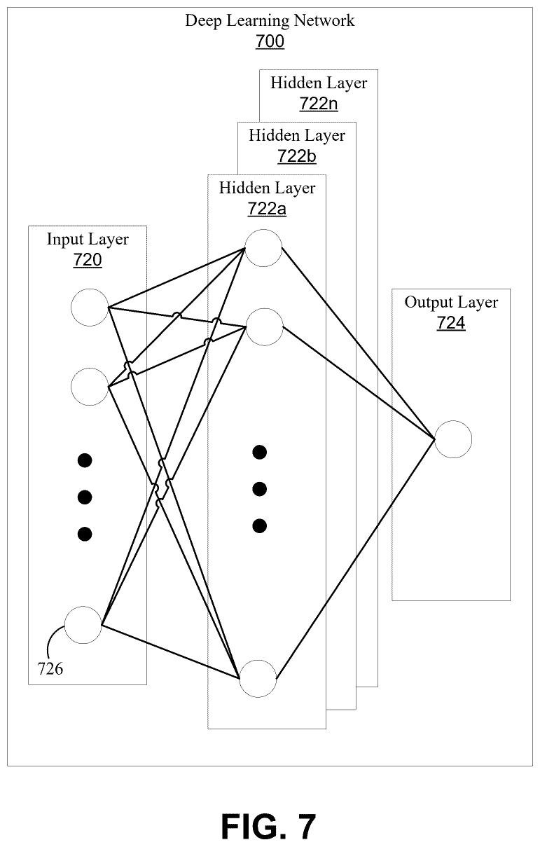

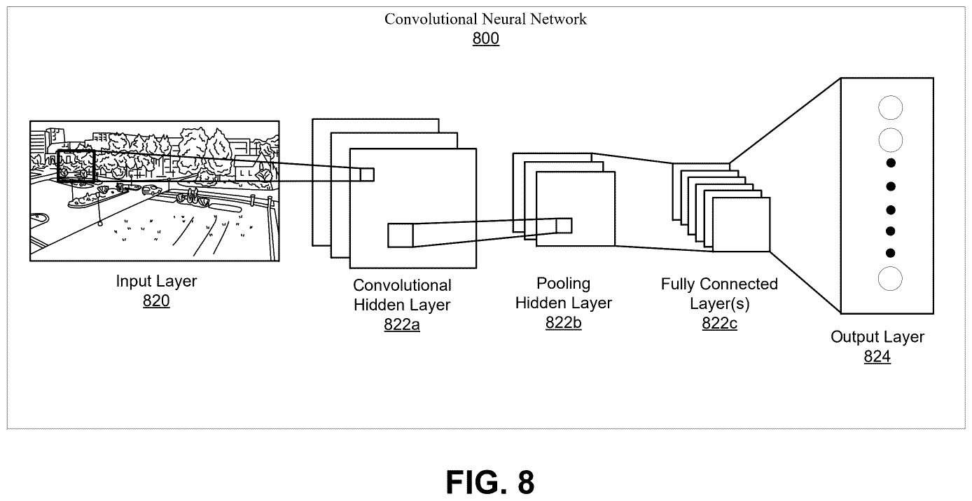

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. Further description of machine learning model architecture is provided in the description of FIG. 2, FIG. 7, and FIG. 8.

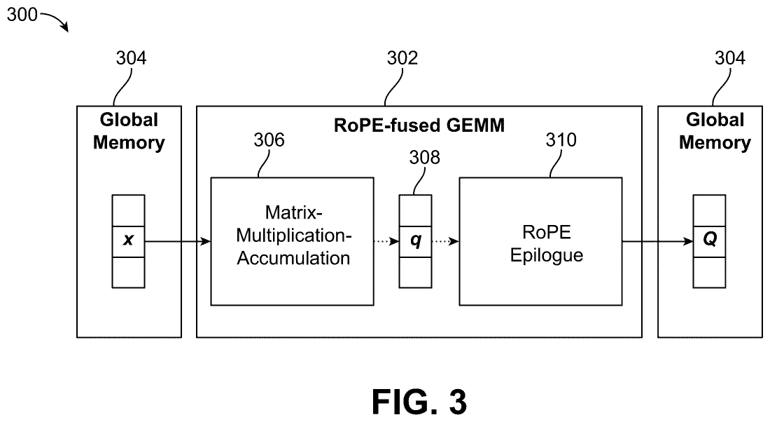

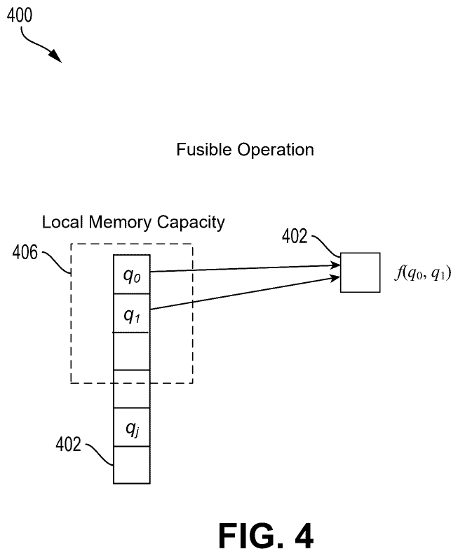

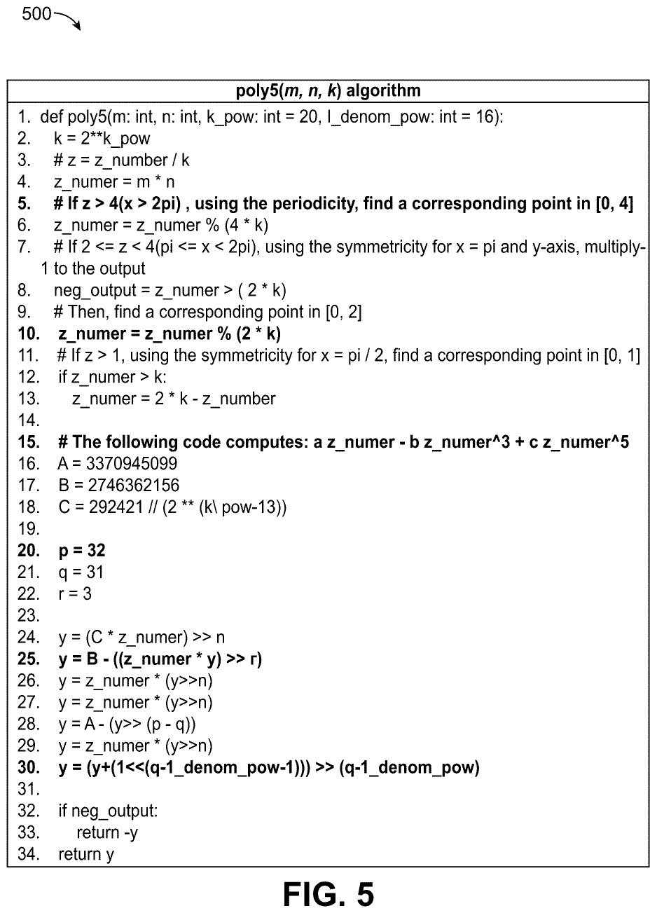

The SOC 100 of FIG. 1 can be used to perform the various systems and techniques described in the descriptions of FIG. 2-FIG. 8. For example, the SOC 100 can be used to perform operations of the transformer 200 of FIG. 2, the neural network 700 of FIG. 7, the convolutional neural network 800 of FIG. 8. The SOC 100 can be used to perform operations of the ROPE fused GEMM kernel 302 of FIG. 3. In another example, the SOC 100 can include a register such as local memory 406 of FIG. 4 and perform algorithm 500 of FIG. 5.

FIG. 2 is a block diagram of an example transformer in accordance with some aspects of the disclosure.

In a convolutional neural network (CNN) model, the number of operations required to relate signals from two arbitrary input or output positions grows in the distance between positions, which makes learning dependencies at different distant positions challenging for a CNN model. A transformer 200 reduces the operations of learning dependencies by using an encoder 210 and a decoder 230 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 210 is composed of a stack of six identical layers and each layer has two sub-layers. The first sub-layer is a multi-head self-attention engine 212, and the second sub-layer is a fully connected feed-forward network 214. A residual connection (not shown) connects around each of the sub-layers followed by normalization.

In this example transformer 200, the decoder 230 is also composed of a stack of six 6 identical layers. The decoder also includes a masked multi-head self-attention engine 232, a multi-head attention engine 234 over the output of the encoder 210, and a fully connected feed-forward network 226. Each layer includes a residual connection (not shown) around the layer, which is followed by layer normalization. The masked multi-head self-attention engine 232 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 240 to encode positions because the model does not contain recurrence and convolution and relative or absolute position of the tokens can be needed. In the transformer 200, the positional encodings are added to the input embeddings at the bottom layer of the encoder 210 and the decoder 230. The positional encodings can be summed with the embeddings because the positional encodings and embeddings have the same dimensions. A corresponding position decoder 250 is configured to decode the positions of the embeddings for the decoder 230. In some examples, the positional encoder 240 can include a ROPE infused GEMM kernel (e.g., the ROPE infused GEMM kernel of FIG. 3) or can receive inputs from the ROPE infused GEMM kernel. In such an example, the positional encodings can be RoPE encodings. In such an example, the positional encoder 240 can receive queries and keys from an input layer of the transformer 200 as inputs. In some examples, the transformer 200 can apply the ROPE function for every query and key computation at each transformer layer of a machine learning model. For example, each query and key be provided as inputs to a positional encoder to determine positional encodings for each query and key. The transformer 200 can apply the ROPE function (or other positional encoding function) for every query and key.

In some aspects, the transformer 200 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 200 can process input sequences of variable length, making it well-suited for natural language processing tasks where input lengths can vary greatly. Additionally, the self-attention mechanism allows the transformer 200 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 3 is a block diagram 300 illustrating an example ROPE fused GEMM kernel 302. The block diagram 300 can represent a processor or computing core of a processor including global memory 304. The ROPE fused GEMM kernel 302 can include a matrix multiplication accumulation operator 306, local memory 308, and a ROPE epilogue 310.

For example, the global memory 304 can represent a main memory pool accessible to the entire system. For example, the global memory 304 can include random access memory (RAM) or dynamic random-access memory (DRAM) which is slower than the local memory 308. In further examples, the global memory 304 can represent a memory location accessible by multiple processors or other components of a computing device (such as the SOC of FIG. 1). The global memory 304 can store data relevant to the multiple processors such as data to be used in multiple operations of the processor. By way of example, x of the global memory can represent an example tensor received by the ROPE fused GEMM as input.

The ROPE fused GEMM can receive the input data at the matrix multiplication accumulation operator 306. The matrix multiplication accumulation operator 306 can perform general matrix multiplication (e.g., GEMM operations). For example, the input data can be a tensor representing a matrix of values. The matrix of values can be floating point values, integer type values, etc. The matrix multiplication accumulation operator 306 can be used to perform matrix multiplication on the input value. In some examples, the input data can be a sequence of tokens. For example, the global memory 304 can include a sequence of floating type values, integer type values, etc. In some examples, the matrix multiplication can include multiplying input data by subsequent input data or weights. In further examples, the matrix multiplication accumulation operator 306 can be used to multiply the input data (e.g., an input tensor) by a query or weight associated with a layer of a machine learning model.

The results of the matrix multiplication accumulation operator 306 (referred to as a kernel output) can be stored in the local memory 308 of a computing core providing the ROPE fused GEMM kernel 302. In some examples, the local memory 308 is a register of the computing core. In such an example, an epilogue of the matrix multiplication accumulation operator (e.g., an epilogue of GEMM), can perform a ROPE function. For example, the ROPE function can be fused, combined, or added to the epilogue of GEMM to provide the ROPE epilogue 310.

The ROPE epilogue 310 can perform ROPE functions on values stored in the local memory 308 of the computing core. For example, the ROPE epilogue 310 can receive multiple values from the local memory 308 to perform ROPE functions. For example, the ROPE epilogue 310 can receive two consecutive inputs such as qᵢ and qᵢ₊₁ (e.g., where qᵢ represents a first input value and qᵢ₊₁ represents a subsequent input value). In such an example, qᵢ and qᵢ₊₁ can be matrices, vectors, tensors, sequences of data, etc. In such an example, the ROPE function of the ROPE epilogue can be represented as:

$${RoPE ( q )}_{i} = \{ \begin{matrix}{q}_{i} cos m {θ}_{i} - {q}_{i + 1} sin m {θ}_{i} , & i ∈ \{ 0 , 2 , ... \} \\ {q}_{i} cos m {θ}_{i} + {q}_{i - 1} sin m {θ}_{i} , & i ∈ \{ 1 , 3 , ... \}\end{matrix} .$$

The ROPE function can be fused with the epilogue of the GEMM kernel in part because the inputs to the ROPE function are close enough in order (e.g., consecutive values) to be accessible within a register of the computing core. Further description of the fusion of the GEMM kernel and the ROPE function is provided in the description of FIG. 4.

In some examples, the ROPE epilogue 310 can be configured to perform RoPE functions on quantized input data (e.g., the data from the local memory 308) to the ROPE epilogue 310. In such an example, the ROPE function can be represented as

$$RoPE ( {\overline{W}}_{Q} \overline{x} ) = RoPE ( \overline{q} ) = ( \begin{matrix}{\overline{q}}_{1} \\ {\overline{q}}_{2} \\ ⋮\end{matrix} ) ⊙ ( \begin{matrix}cos m {θ}_{1} \\ cos m {θ}_{1} \\ ⋮\end{matrix} ) + ( \begin{matrix}- {\overline{q}}_{2} \\ {\overline{q}}_{1} \\ ⋮\end{matrix} ) ⊙ ( \begin{matrix}sin m {θ}_{1} \\ sin m {θ}_{1} \\ ⋮\end{matrix} ) where {\overline{W}}_{q} ∈$$

$${ℤ}^{m \times n} ; \overline{q} , \overline{x} ∈ {ℤ}^{n \times 1} , m ∈ ℤ , and {θ}_{i} ∈ ℝ .$$

In such an example, W̅_{Q}x̅ can represent a weighted (W̅_{Q}) tensor (x̅) where the weight and the tensor are both quantized (e.g., integer value representations). In some examples, the ROPE epilogue 310 can perform RoPE functions on quantized values by dequantizing the quantized values and performing RoPE functions on the dequantized values. For example, trigonometric operations of the ROPE functions of the ROPE epilogue can be floating point representations of trigonometric operations (e.g., floating point representation of sine and cosine). In such an example, the ROPE function can be represented as:

$$RoPE ( q ) = dequant ( \begin{matrix}{\overline{q}}_{1} \\ {\overline{q}}_{2} \\ ⋮\end{matrix} ) ⊙ ( \begin{matrix}cos m {θ}_{1} \\ cos m {θ}_{1} \\ ⋮\end{matrix} ) + dequant ( \begin{matrix}- {\overline{q}}_{2} \\ {\overline{q}}_{1} \\ ⋮\end{matrix} ) ⊙ ( \begin{matrix}sin m {θ}_{1} \\ sin m {θ}_{1} \\ ⋮\end{matrix} )$$

$$where dequant ( \cdot ) : {ℤ}^{n \times 1} \to {ℝ}^{n \times 1}$$

[symbol]

can represent a conversion from integer values to floating point representations of the integer values. The ROPE epilogue 310 can perform the ROPE function with the dequantized values. In some examples, the output of the ROPE epilogue 310 can be quantized by converting the floating point output of the ROPE epilogue 310 to integers.

In some examples, the ROPE function of the ROPE epilogue 310 can be configured to receive quantized inputs and generate quantized outputs. In such an example, the ROPE epilogue 310 can use a polynomial approximation of the trigonometric operations of the ROPE function (e.g., polynomial representation of sine and cosine functions). Further description of the polynomial representation of the trigonometric operations is provided in the description of FIG. 5. The output of the ROPE epilogue 310 can be stored in global memory 304.

FIG. 4 is a block diagram 400 illustrating an example of characteristics of fusible operations performable using a ROPE fused GEMM kernel. The block diagram 400 includes global memory 402 and local memory 406 of a computing device or processor performing operations of the ROPE fused GEMM kernel. For example, the local memory 406 can be a register of a computing core of a processor. In such an example, the global memory 402 can be a main memory of the computing device, which is low-speed memory as compared to the local memory 406.

In such an example, the characteristics of ROPE functions which can allow the ROPE function to be fusible with an epilogue of GEMM can include that the inputs of the RoPE function can be consecutive outputs of GEMM. For example, because the ROPE function can perform operations on the values output by the GEMM which are stored in local memory 406 of a computing core, the ROPE function can be fused with the epilogue of the GEMM model. As shown in FIG. 4, the output of the of the ROPE function (ƒ(q₀,q₁)) can be stored in the global memory 402.

FIG. 5 is a block diagram illustrating an example pseudo code algorithm 500 for performing fifth order polynomial estimation of trigonometric operations to be performed using a ROPE fused GEMM kernel (e.g., the ROPE fused GEMM kernel 302 of FIG. 3). In some examples, the pseudo code algorithm can be used when the ROPE function of the ROPE fused GEMM kernel uses integer values to represent trigonometric operations.

In such an example, the algorithm 500 can include approximating the cos me function (and the sine function as

$$sin m θ = cos ( m θ + \frac{π}{2} )$$

using polynomial approximations. For example, the cosine of the ROPE function can be approximated to

$$cos m θ := \frac{f ( m , m , k )}{{I}_{denom}}$$

where ƒ(m,n,k):

$$ℤ \times ℤ \times ℤ \to ℤ , θ ≅ \frac{n}{k} ,$$

and I_{denom}∈ [symbol] .

In some examples, ƒ(m,n,k) can represent a polynomial function used to approximate a numerator of the cosine function. For example, ƒ(m,n,k) can be a fifth order polynomial. Approximating the cosine function by a fifth order polynomial can include simplifying the cosine function in terms of sine and based on the properties of the sine function. For example, the cosine function can be obtained by shifting π/2 phase of the sine function to generate

$$cos x = sin ( x + \frac{π}{2} ) .$$

Further, the sine function is a periodic function, so that sinx=sin(x+2πi) for i=1, 2, . . . . The sine function is symmetric for

$$x = \frac{π}{2} ,$$

sin x=sin(π−x). The sine function is symmetric for x=π and y-axis, sin x=−sin(2π−x). Based on the properties of sine function, the cosine function can be approximated by computing sin mθ for

$$0 \leq m θ < \frac{π}{2}$$

(e.g., because sine is periodic, the integer computation over this range can be used to approximate the cosine function).

The sine function can be approximated to a polynomial (e.g., a fifth order polynomial) (poly5(z)). For example, the sine function can be approximated as sin (z)≅poly5(z)=az−bz³+cz⁵, where

$$a = 4 ( \frac{3}{π} - \frac{9}{16} ) , b = 2 ( \frac{3}{π} - \frac{9}{16} ) , c = 4 ( \frac{3}{π} - \frac{9}{16} ) , and z = \frac{x}{0.5 π} ∈ [ 0 , 1 ] .$$

In such an example, the approximation can include approximating the sine function over the z∈[0,1] domain.

The approximation can include determining

$$poly 5 ( \frac{m θ}{0.5 π} ) ,$$

where

$$\frac{θ}{0.5 π}$$

is a real value and an integer value

$$( e . g . , \frac{θ}{0.5 π} ≅ \frac{n}{k} , n = round ( \frac{θ k}{0.5 π} ) )$$

where n and k are integers, n is stored in memory and k is a predetermined large integer value (e.g., k=2²⁰).

The algorithm 500 can be a computer program to compute the numerator of

$$poly 5 ( \frac{m θ}{0.5 π} )$$

where

$$poly 5 ( \frac{m θ}{0.5 π} ) ≅ \frac{\overline{poly 5} ( m , n , k )}{{I}_{denom}}$$

with a predetermined I_{denom}=2¹⁶.

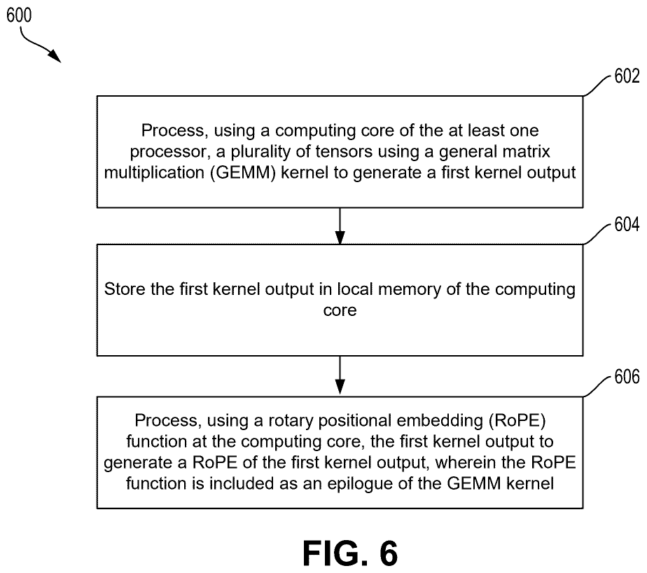

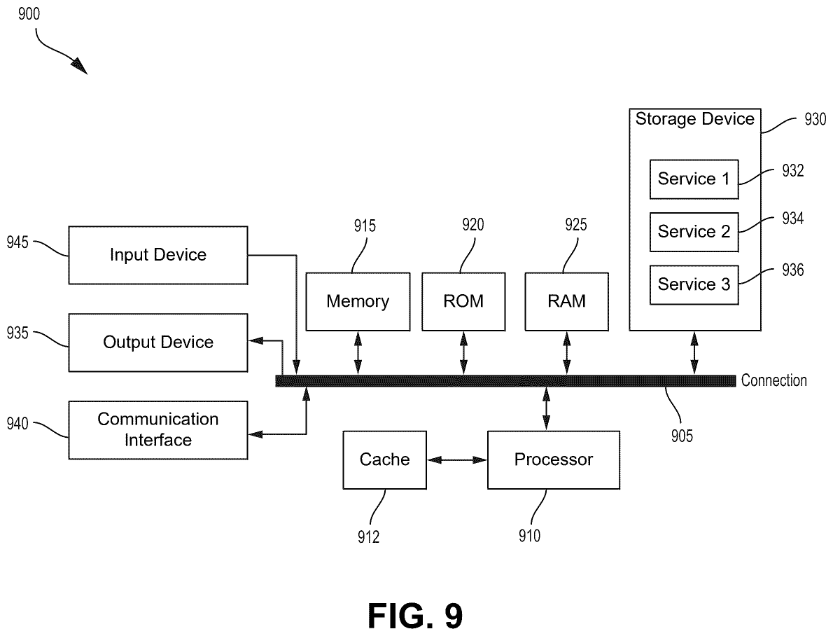

FIG. 6 is a flow diagram illustrating an example process 600 for data processing. In particular, the process 600 illustrates an example process data processing, performed using a processor (e.g., the CPU 102 of FIG. 1 or the processor 910 of FIG. 9). Computing cores of the processor can be used to perform the process 600 of data processing using a ROPE fused GEMM kernel, such as the ROPE fused GEMM kernel 302 of FIG. 3. The ROPE fused GEMM kernel can be part of a machine learning model, or provide embeddings to the machine learning model, such as the transformer 200 of FIG. 3, the neural network 700 of FIG. 7, the convolutional neural network of FIG. 8, an LLM, etc. The process 600 can be performed by a computing device (e.g., the computing device or computing system 900 of FIG. 9, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 600 can be implemented as software components that are executed and run on one or more processors (e.g., CPU 102 of FIG. 1, the processor 910 of FIG. 9, or other processor(s)) of the computing device. Further, the transmission and reception of signals by the computing device in the process 600 can be enabled, for example, by one or more antennas and/or one or more transceivers (e.g., wireless transceiver(s)).

At block 602, a computing device (or component thereof) can process, using a computing core of the at least one processor, a plurality of tensors using a general matrix multiplication (GEMM) kernel (e.g., the ROPE fused GEMM kernel 302 of FIG. 3) to generate a first kernel output. In some examples, the computing core is part of the at least one processor. For example, the at least one processor can include multiple computing cores. In some examples, the plurality of tensors can be associated with a query vector and a key vector of a machine learning model (e.g., the neural network 700 of FIG. 7, the CNN 800 of FIG. 8, etc.). For example, the machine learning model can include transformer architecture (e.g., the transformer 200 of FIG. 2). In further examples, the machine learning model can be a large language model (LLM). In another example, the computing device can receive the plurality of tensors from an input layer of a machine learning model.

At block 604, a computing device (or component thereof) can store the first kernel output in local memory of the computing core. The local memory can include registers of the computing core and a cache used by multiple computing cores of the at least one processor. In some examples, the first kernel output can be stored in a register of the computing core. The at least one processor can access global memory of the computing device. For example, the global memory (e.g., the global memory 304 of FIG. 3) can be memory of the computing device accessible by the at least one processor such as RAM, DRAM, etc.

At block 606, a computing device (or component thereof) can process, using a rotary positional embedding (RoPE) function at the computing core, the first kernel output to generate a RoPE of the first kernel output, wherein the ROPE function is included as an epilogue of the GEMM kernel. In some examples, the computing device can process, using the ROPE function at the computing core, the first kernel output to generate the RoPE of the first kernel output. In such an example, the ROPE function can use an integer representation of trigonometric operations to determine the ROPE. In some examples, the trigonometric operations can include approximations of sine or cosine functions. (e.g., the approximations further described in the description of FIG. 5). In some examples, the trigonometric operations can include a fifth order polynomial approximation of cosine or sine operations (e.g., a polynomial with five variables to approximate a sine or cosine function as further described in the description of FIG. 5).

In some examples, the computing device (or component thereof such as at least one processor) can quantize the plurality of tensors. In such an example, the computing device can process, using the computing core of the at least one processor, the plurality of tensors using the GEMM kernel to generate the first kernel output. In some examples, the first kernel output is quantized. In a further example, the computing device (or component thereof) can process the first kernel output using the ROPE function at the computing core to generate the ROPE of the first kernel output. In some examples, the RoPE function can be included as the epilogue of the GEMM kernel. In such an example, the computing device can dequantize the ROPE (e.g., the output of the ROPE function). In another example, the computing device can process two consecutive kernel outputs stored in the local memory of the computing core to generate the ROPE of two consecutive kernel outputs. For example, the computing device can process the two consecutive kernel outputs using the ROPE function such as by using the ROPE epilogue of the GEMM kernel (e.g., the ROPE epilogue 310 of FIG. 3).

FIG. 7 is an illustrative example of a deep learning neural network 700 that can be used by the SOC 100. An input layer 720 includes input data. In one illustrative example, the input layer 720 can include data representing the pixels of an input image or video frame. The neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. The neural network 700 further includes an output layer 724 that provides an output resulting from the processing performed by the hidden layers 722a, 722b, through 722n. In one illustrative example, the output layer 724 can provide a classification for an object in an input image or video frame. The classification can include a class identifying the type of object (e.g., a static object, a vehicle, a person, a dog, a cat, or other object).

The neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the hidden layers 722a, 722b, through 722n can transform the information of each input node by applying activation functions to the information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 724, at which an output is provided. In some cases, while nodes (e.g., node 726) in the neural network 700 are shown as having multiple output lines, a node has a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 724. In an example in which the neural network 700 is used to identify objects in images, the neural network 700 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0 ].

In some cases, the neural network 700 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 700 is trained well enough so that the weights of the layers are accurately tuned.

For the example of identifying objects in images, the forward pass can include passing a training image through the neural network 700. The weights are initially randomized before the neural network 700 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 700, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 700 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 700 can perform a backward pass by determining which inputs (weights) most contributed to the loss of the network and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and n denotes a learning rate. The learning rate can be set to any suitable value, with a high learning rate including larger weight updates and a lower value indicating smaller weight updates.

The neural network 700 can include any suitable deep network. One example includes a convolutional neural network (CNN), which includes an input layer and an output layer, with multiple hidden layers between the input and out layers. An example of a CNN is described below with respect to FIG. 7. The hidden layers of a CNN include a series of convolutional, nonlinear, pooling (for downsampling), and fully connected layers. The neural network 700 can include any other deep network other than a CNN, such as an autoencoder, a deep belief nets (DBNs), a Recurrent Neural Networks (RNNs), among others.

FIG. 8 is an illustrative example of a convolutional neural network 800 (CNN 800). The input layer 820 of the CNN 800 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 822a, an optional non-linear activation layer, a pooling hidden layer 822b, and fully connected hidden layers 822c to get an output at the output layer 824. While only one of each hidden layer is shown in FIG. 8, one of ordinary skill will appreciate that multiple convolutional hidden layers, non-linear layers, pooling hidden layers, and/or fully connected layers can be included in the CNN 800. As previously described, the output can indicate a single class of an object or can include a probability of classes that best describe the object in the image.

The first layer of the CNN 800 is the convolutional hidden layer 822a. The convolutional hidden layer 822a analyzes the image data of the input layer 820. Each node of the convolutional hidden layer 822a is connected to a region of nodes (pixels) of the input image called a receptive field. The convolutional hidden layer 822a can be considered as one or more filters (each filter corresponding to a different activation or feature map), with each convolutional iteration of a filter being a node or neuron of the convolutional hidden layer 822a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 822a. Each connection between a node and a receptive field for that node learns a weight and, in some cases, an overall bias such that each node learns to analyze its particular local receptive field in the input image. Each node of the hidden layer 822a will have the same weights and bias (called a shared weight and a shared bias). For example, the filter has an array of weights (numbers) and the same depth as the input. A filter will have a depth of 3 for the image or video frame example (according to three color components of the input image). An illustrative example size of the filter array is 5×5×3, corresponding to a size of the receptive field of a node.

The convolutional nature of the convolutional hidden layer 822a is due to each node of the convolutional layer being applied to its corresponding receptive field. For example, a filter of the convolutional hidden layer 822a can begin in the top-left corner of the input image array and can convolve around the input image. As noted above, each convolutional iteration of the filter can be considered a node or neuron of the convolutional hidden layer 822a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 822a. For example, a filter can be moved by a step amount to the next receptive field. The step amount can be set to 1 or another suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 822a.

The mapping from the input layer to the convolutional hidden layer 822a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 822a can include several activation maps in order to identify multiple features in an image. The example shown in FIG. 8 includes three activation maps. Using three activation maps, the convolutional hidden layer 822a can detect three different kinds of features, with each feature being detectable across the entire image.

In some examples, a non-linear hidden layer can be applied after the convolutional hidden layer 822a. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 800 without affecting the receptive fields of the convolutional hidden layer 822a.

The pooling hidden layer 822b can be applied after the convolutional hidden layer 822a (and after the non-linear hidden layer when used). The pooling hidden layer 822b is used to simplify the information in the output from the convolutional hidden layer 822a. For example, the pooling hidden layer 822b can take each activation map output from the convolutional hidden layer 822a and generates a condensed activation map (or feature map) using a pooling function. Max-pooling is one example of a function performed by a pooling hidden layer. Other forms of pooling functions be used by the pooling hidden layer 822a, such as average pooling, L2-norm pooling, or other suitable pooling functions. A pooling function (e.g., a max-pooling filter, an L2-norm filter, or other suitable pooling filter) is applied to each activation map included in the convolutional hidden layer 822a. In the example shown in FIG. 8, three pooling filters are used for the three activation maps in the convolutional hidden layer 822a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 822a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 822a having a dimension of 24×24 nodes, the output from the pooling hidden layer 822b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 800.

The final layer of connections in the network is a fully-connected layer that connects every node from the pooling hidden layer 822b to every one of the output nodes in the output layer 824. Using the example above, the input layer includes 28×28 nodes encoding the pixel intensities of the input image, the convolutional hidden layer 822a includes 3×24×24 hidden feature nodes based on application of a 5×5 local receptive field (for the filters) to three activation maps, and the pooling layer 822b includes a layer of 3×12×12 hidden feature nodes based on application of max-pooling filter to 2×2 regions across each of the three feature maps. Extending this example, the output layer 824 can include ten output nodes. In such an example, every node of the 3×12×12 pooling hidden layer 822b is connected to every node of the output layer 824.

The fully connected layer 822c can obtain the output of the previous pooling layer 822b (which should represent the activation maps of high-level features) and determines the features that most correlate to a particular class. For example, the fully connected layer 822c layer can determine the high-level features that most strongly correlate to a particular class and can include weights (nodes) for the high-level features. A product can be computed between the weights of the fully connected layer 822c and the pooling hidden layer 822b to obtain probabilities for the different classes. For example, if the CNN 800 is being used to predict that an object in an image or video frame is a vehicle, high values will be present in the activation maps that represent high-level features of vehicles (e.g., two or four tires, a windshield, side view mirrors, etc.).

In some examples, the output from the output layer 824 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.9 0 0 0 0], the vector indicates that there is a 5% probability that the image is the third class of object (e.g., a person), an 80% probability that the image is the fourth class of object (e.g., a static object on a road or other driving surface), and a 9% probability that the image is the sixth class of object (e.g., a vehicle). The probability for a class can be considered a confidence level that the object is part of that class.

FIG. 9 is a diagram illustrating an example of a system for implementing certain aspects of the present technology, such as those described with respect to the block diagram 300 of FIG. 3, the process 600 of FIG. 6, and/or other aspects described herein. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, an engine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for data processing, the apparatus comprising: at least one memory; and at least one processor coupled to the at least one memory and configured to: process, using a computing core of the at least one processor, a plurality of tensors using a general matrix multiplication (GEMM) kernel to generate a first kernel output; store the first kernel output in local memory of the computing core; and process, using a rotary positional embedding (RoPE) function at the computing core, the first kernel output to generate a RoPE of the first kernel output, wherein the ROPE function is included as an epilogue of the GEMM kernel.

Aspect 2. The apparatus of Aspect 1, wherein the at least one processor is configured to: quantize the plurality of tensors; process, using the computing core of the at least one processor, the plurality of tensors using the GEMM kernel to generate the first kernel output, wherein the first kernel output is quantized; and process, using the RoPE function at the computing core, the first kernel output to generate the ROPE of the first kernel output, wherein the ROPE function is included as the epilogue of the GEMM kernel, and the ROPE is dequantized.

Aspect 3. The apparatus of any of Aspects 1 to 2, wherein the at least one processor is configured to: process, using the ROPE function at the computing core, the first kernel output to generate the ROPE of the first kernel output, wherein the ROPE function uses an integer representation of trigonometric operations to determine the ROPE.

Aspect 4. The apparatus of any of Aspects 1 to 3, wherein the integer representation of the trigonometric operations includes a fifth order polynomial approximation of cosine or sine operations.

Aspect 5. The apparatus of any of Aspects 1 to 4, wherein the computing core is part of the at least one processor.

Aspect 6. The apparatus of any of Aspects 1 to 5, wherein the plurality of tensors are associated with a query vector and a key vector of a machine learning model.

Aspect 7. The apparatus of any of Aspects 1 to 6, wherein the machine learning model is a large language model (LLM).

Aspect 8. The apparatus of any of Aspects 1 to 7, wherein the at least one processor is configured to: receive the plurality of tensors from an input layer of a machine learning model.

Aspect 9. The apparatus of any of Aspects 1 to 8, wherein at least one processor is configured to: process, using the ROPE function, two consecutive kernel outputs stored in the local memory of the computing core to generate the ROPE of two consecutive kernel outputs.

Aspect 10. A method for data processing, the apparatus comprising: processing, using a computing core of the at least one processor, a plurality of tensors using a general matrix multiplication (GEMM) kernel to generate a first kernel output; storing the first kernel output in local memory of the computing core; and processing, using a rotary positional embedding (RoPE) function at the computing core, the first kernel output to generate a RoPE of the first kernel output, wherein the ROPE function is included as an epilogue of the GEMM kernel.

Aspect 11. The method of Aspect 10, further comprising: quantizing the plurality of tensors; processing, using the computing core of the at least one processor, the plurality of tensors using the GEMM kernel to generate the first kernel output, wherein the first kernel output is quantized; and processing, using the ROPE function at the computing core, the first kernel output to generate the ROPE of the first kernel output, wherein the ROPE function is included as the epilogue of the GEMM kernel, and the RoPE is dequantized.

Aspect 12. The method of any of Aspects 10 to 11, further comprising: processing, using the ROPE function at the computing core, the first kernel output to generate the ROPE of the first kernel output, wherein the ROPE function uses an integer representation of trigonometric operations to determine the ROPE.

Aspect 13. The method of any of Aspects 10 to 12, wherein the integer representation of the trigonometric operations includes a fifth order polynomial approximation of cosine or sine operations.

Aspect 14. The method of any of Aspects 10 to 13, wherein the computing core is part of the at least one processor.

Aspect 15. The method of any of Aspects 10 to 14, wherein the plurality of tensors are associated with a query vector and a key vector of a machine learning model.

Aspect 16. The method of any of Aspects 10 to 15, wherein the machine learning model is a large language model (LLM).

Aspect 17. The method of any of Aspects 10 to 16, further comprising: receiving the plurality of tensors from an input layer of a machine learning model.

Aspect 18. The method of any of Aspects 10 to 17, further comprising: processing, using the ROPE function, two consecutive kernel outputs stored in the local memory of the computing core to generate the ROPE of two consecutive kernel outputs.

Aspect 19. A non-transitory computer-readable medium having stored thereon instructions that, when executed by at least one processor, cause the at least one processor to perform one or more of operations according to any of Aspects 10 to 18.

Aspect 20. An apparatus for data processing, the apparatus comprising one or more means for performing operations according to any of Aspects 10 to 18.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

What is claimed is:

1. An apparatus for data processing, the apparatus comprising:
at least one memory; and
at least one processor coupled to the at least one memory and configured to:
process, using a computing core of the at least one processor, a plurality of tensors using a general matrix multiplication (GEMM) kernel to generate a first kernel output;
store the first kernel output in local memory of the computing core; and
process, using a rotary positional embedding (RoPE) function at the computing core, the first kernel output to generate a ROPE of the first kernel output, wherein the ROPE function is included as an epilogue of the GEMM kernel.

2. The apparatus of claim 1, wherein the at least one processor is configured to:
quantize the plurality of tensors;
process, using the computing core of the at least one processor, the plurality of tensors using the GEMM kernel to generate the first kernel output, wherein the first kernel output is quantized; and
process, using the ROPE function at the computing core, the first kernel output to generate the ROPE of the first kernel output, wherein the ROPE function is included as the epilogue of the GEMM kernel, and the ROPE is dequantized.

3. The apparatus of claim 1, wherein the at least one processor is configured to:
process, using the ROPE function at the computing core, the first kernel output to generate the ROPE of the first kernel output, wherein the ROPE function uses an integer representation of trigonometric operations to determine the ROPE.

4. The apparatus of claim 3, wherein the integer representation of the trigonometric operations includes a fifth order polynomial approximation of cosine or sine operations.

5. The apparatus of claim 1, wherein the computing core is part of the at least one processor.

6. The apparatus of claim 1, wherein the plurality of tensors are associated with a query vector and a key vector of a machine learning model.

7. The apparatus of claim 6, wherein the machine learning model is a large language model (LLM).

8. The apparatus of claim 1, wherein the at least one processor is configured to:
receive the plurality of tensors from an input layer of a machine learning model.

9. The apparatus of claim 1, wherein at least one processor is configured to:
process, using the ROPE function, two consecutive kernel outputs stored in the local memory of the computing core to generate the ROPE of two consecutive kernel outputs.

10. A method for data processing, the method comprising:
processing, using a computing core of at least one processor, a plurality of tensors using a general matrix multiplication (GEMM) kernel to generate a first kernel output;
storing the first kernel output in local memory of the computing core; and
processing, using a rotary positional embedding (RoPE) function at the computing core, the first kernel output to generate a ROPE of the first kernel output, wherein the RoPE function is included as an epilogue of the GEMM kernel.

11. The method of claim 10, further comprising:
quantizing the plurality of tensors;
processing, using the computing core of the at least one processor, the plurality of tensors using the GEMM kernel to generate the first kernel output, wherein the first kernel output is quantized; and
processing, using the ROPE function at the computing core, the first kernel output to generate the ROPE of the first kernel output, wherein the ROPE function is included as the epilogue of the GEMM kernel, and the ROPE is dequantized.

12. The method of claim 10, further comprising:
processing, using the ROPE function at the computing core, the first kernel output to generate the ROPE of the first kernel output, wherein the ROPE function uses an integer representation of trigonometric operations to determine the ROPE.

13. The method of claim 12, wherein the integer representation of the trigonometric operations includes a fifth order polynomial approximation of cosine or sine operations.

14. The method of claim 10, wherein the computing core is part of the at least one processor.

15. The method of claim 10, wherein the plurality of tensors are associated with a query vector and a key vector of a machine learning model.

16. The method of claim 15, wherein the machine learning model is a large language model (LLM).

17. The method of claim 10, further comprising:
receiving the plurality of tensors from an input layer of a machine learning model.

18. The method of claim 10, further comprising:
processing, using the ROPE function, two consecutive kernel outputs stored in the local memory of the computing core to generate the ROPE of two consecutive kernel outputs.

19. A non-transitory computer-readable medium having stored thereon instructions that, when executed by at least one processor, cause the at least one processor to:
process, using a computing core of the at least one processor, a plurality of tensors using a general matrix multiplication (GEMM) kernel to generate a first kernel output;
store the first kernel output in local memory of the computing core; and
process, using a rotary positional embedding (RoPE) function at the computing core, the first kernel output to generate a ROPE of the first kernel output, wherein the RoPE function is included as an epilogue of the GEMM kernel.

20. The non-transitory computer-readable medium of claim 19, wherein the instructions, when executed by the at least one processor, cause the at least one processor to:
quantize the plurality of tensors;
process, using the computing core of the at least one processor, the plurality of tensors using the GEMM kernel to generate the first kernel output, wherein the first kernel output is quantized; and
process, using the ROPE function at the computing core, the first kernel output to generate the ROPE of the first kernel output, wherein the ROPE function is included as the epilogue of the GEMM kernel, and the ROPE is dequantized.
